(19) United States
(12) Patent Application Publication
(10) Pub. No.: US 2026/0307178 A1
(43) Pub. Date: Oct. 8, 2026

(54) Lens Protector Assembly

(71) Applicant: Challenge Manufacturing Company, Walker, MI (US)

(72) Inventors: Donald Barrigar, Holland, MI (US); Kevin St. Bernard, Monroe, MI (US); Sang Lee, Troy, MI (US); Tyler Mounts, Troy, MI (US); David Holmes, Coopersville, MI (US)

(21) Appl. No.: 19/564,308

(22) Filed: Mar. 12, 2026

Related U.S. Application Data
(60) Provisional application No. 63/785,258, filed on Apr. 8, 2025.

(51) Int. Cl. B23K 26/70

(52) U.S. Cl. CPC B23K 26/706

(57) ABSTRACT

A lens protector assembly includes an outer housing and an inner housing. The outer housing includes a fluid inlet and an frustoconical inner surface defining a cavity. The fluid inlet defines an axis. The inner housing is coupled to the outer housing and concentrically disposed within the cavity, the inner housing includes a frustoconical outer surface. The axis is parallel to a tangent of the outer surface. The inner and outer surfaces collectively define a frustoconical fluid flow path in communication with the fluid inlet.

### CROSS-REFERENCE TO RELATED APPLICATIONS

This application claims the benefit of U.S. Provisional Application No. 63/785,258 filed Apr. 8, 2025, the entire disclosure of which is incorporated by reference.

### FIELD

The present disclosure relates to a lens protector assembly and more particularly to a lens protector assembly for a laser.

### BACKGROUND

In laser welding applications, debris from the workpiece or surrounding environment can accumulate on the laser lens during operation, potentially degrading the quality of the laser beam and affecting the precision and effectiveness of the weld. The accumulation of debris on the lens may cause refraction or scattering of the laser light, leading to diminished performance, increased wear, and potential damage to the lens. While known systems and methods for cleaning, and/or preventing the accumulation of debris on, the lens have proven acceptable for their intended purposes, there remains a continuous need for improvement in the relevant art.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A lens protector assembly includes an outer housing and an inner housing. The outer housing includes a fluid inlet and an frustoconical inner surface defining a cavity. The fluid inlet defines an axis. The inner housing is coupled to the outer housing and concentrically disposed within the cavity, the inner housing includes a frustoconical outer surface. The axis is parallel to a tangent of the outer surface. The inner and outer surfaces collectively define a frustoconical fluid flow path in communication with the fluid inlet.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is an exploded view of an example lens protector assembly in accordance with the principles of the present disclosure.

FIG. 2 is a perspective view of the lens protector assembly of FIG. 1 in an assembled configuration.

FIG. 3 is a perspective view of an example outer housing of a lens protector assembly in accordance with the principles of the present disclosure.

FIG. 4 is a perspective view of an example inner housing of a lens protector assembly in accordance with the principles of the present disclosure.

FIG. 5 is a bottom view of the lens protector assembly of FIG. 2.

FIG. 6 is a cross-sectional view of the lens protector assembly of FIG. 2 taken through the line 6-6.

FIG. 7 is a cross-sectional view of the lens protector assembly of FIG. 5 taken through the line 7-7.

In the drawings, reference numbers may be reused to identify similar and/or identical elements.

### DETAILED DESCRIPTION

### Introduction

A lens protector assembly can be used to prevent the accumulation of debris on a lens for a laser welding apparatus, thereby maintaining the integrity of the laser beam and the overall efficiency of the welding process. For example, by directing air onto a workpiece, the lens protector assembly can help to deflect or displace debris in real time, ensuring consistent laser focus and enhancing the precision of the welding operation. This air flow serves to protect both the lens and the quality of the weld, extending the life of the equipment and improving the reliability of the laser welding process.

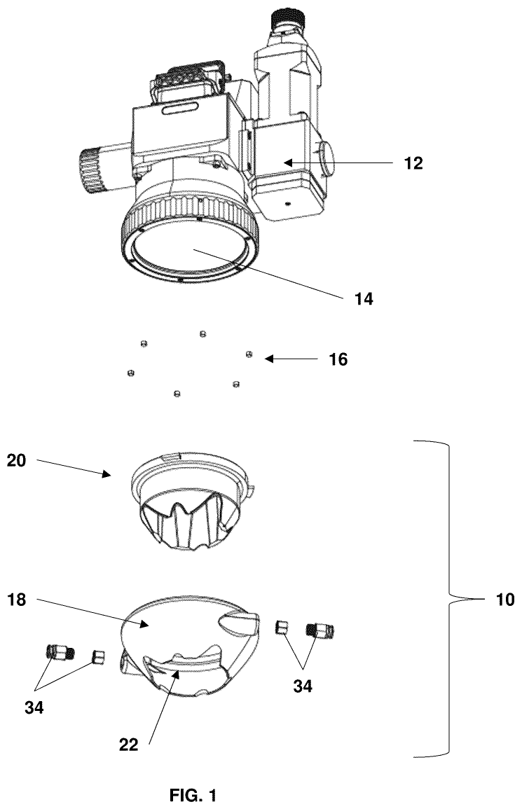

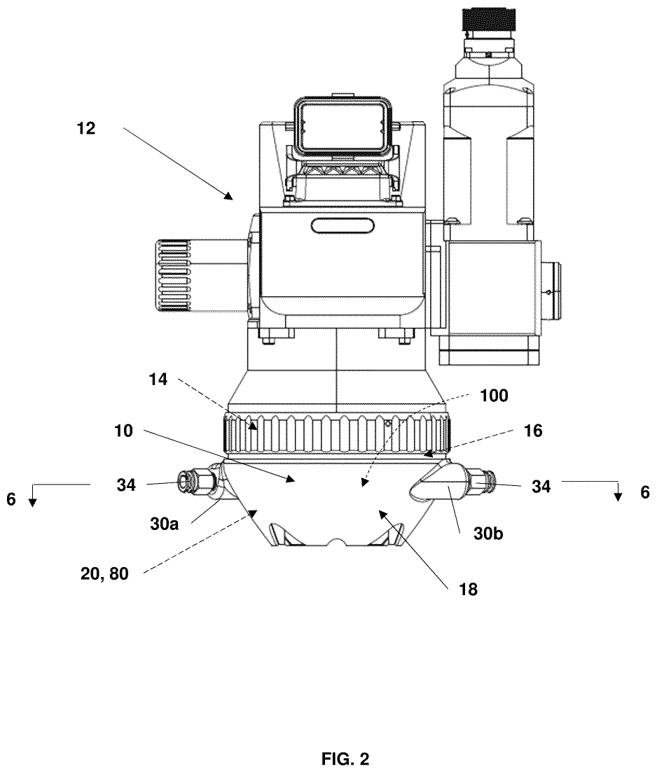

With reference to FIGS. 1 and 2, an example lens protector assembly 10 is shown. The assembly 10 may be detachably coupled to a laser assembly 12 having a lens 14. In some implementations, the assembly 10 is detachably coupled to the laser assembly 12 via one or more magnets 16. In an assembled configuration, the assembly 10 may enclose at least a portion of the lens 14.

In various implementations, the assembly 10 includes an outer housing 18 and an inner housing 20, among others. The inner housing 20 connects to the outer housing 18. As will be explained in more detail below, the outer housing 18 defines a cavity 22. In the assembled configuration, the inner housing 20 may be concentrically disposed within the cavity 22.

### Outer Housing

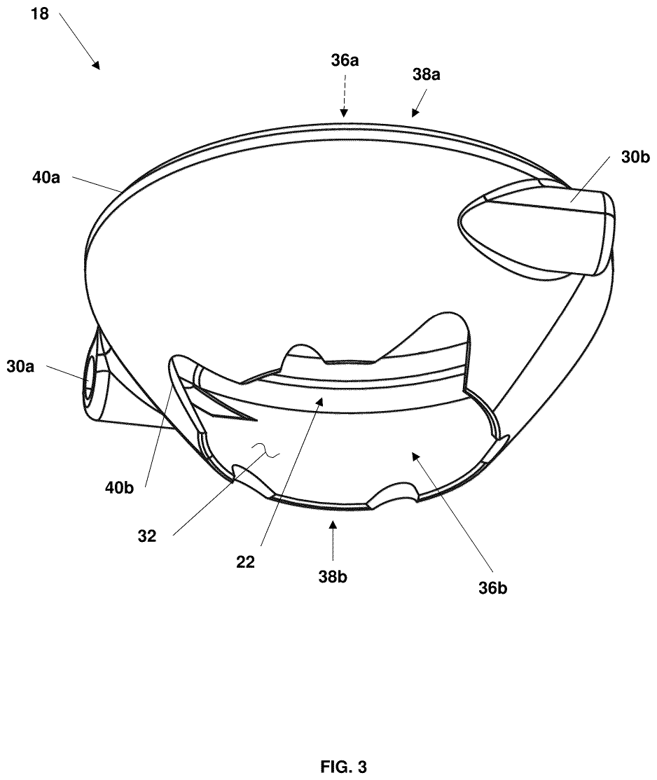

With reference to FIG. 3, an example outer housing 18 is shown. The outer housing 18 may comprise one or more of a variety of shapes, sizes, configurations, and/or materials. In various implementations, the outer housing 18 includes a first fluid inlet 30a, a second fluid inlet 30b, and a frustoconical inner surface 32, among others. The first and second fluid inlets 30a, 30b may each connect, via one or more fittings 34 (see, e.g., FIGS. 1 and 2), with an air supply line (not depicted) so that fluid (e.g., pressurized air) can be supplied to the assembly 10. The inner surface 32 may define the cavity 22.

In various implementations, the outer housing 18 defines a first aperture 36a and a second aperture 36b. The first aperture 36a may be disposed proximate a first end 38a of the outer housing 18 and the second aperture 36b may be disposed proximate a second end 38b opposite the first end 38a. The first and second apertures 36a, 36b are in fluid communication with the cavity 22.

In various implementations, the cavity 22 is accessible through the first end 38a via the first aperture 36a and the cavity 22 is accessible through the second end 38b via the second aperture 36b. In various implementations, a first edge 40a of the outer housing 18 defines the first aperture 36a and a second edge 40b defines the second aperture 36b. The first edge 40a may define a circular or an oval-shaped configuration, among others. The second edge 40b may define a freeform configuration, among others. In some implementations, the second edge 40b defines a shape having a plurality (e.g., six) of lobes. In some implementations, a first portion (e.g., three lobes) of the second edge 40b defines a first triangle, and a second portion (e.g., three lobes) of the second edge 40b defines a second triangle. The shape (e.g., plurality of lobes) of the second edge 40b may allow for the most efficient use of the laser assembly 12 through the second aperture 36b.

### Inner Housing

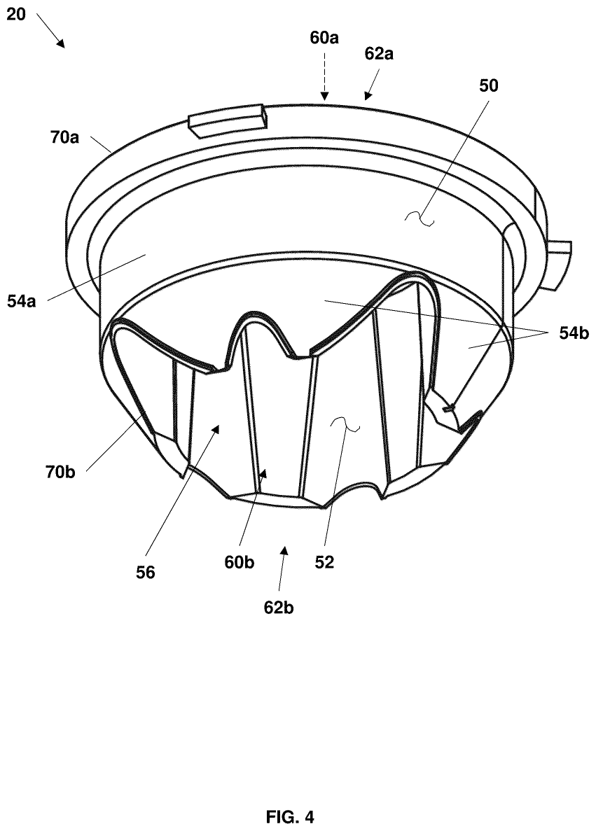

With reference to FIG. 4, an example inner housing 20 is shown. The inner housing 20 may comprise one or more of a variety of shapes, sizes, configurations, and/or materials. In various implementations, the inner housing 20 includes a frustoconical outer surface 50 and an inner surface 52 opposite the outer surface 50, among others. In some example configurations, the outer surface 50 includes a first portion 54a and a set of second portions 54b extending from the first portion 54a. The first portion 54a may define a ring or cylindrical-shaped configuration, among others. In various implementations, the inner surface 52 defines a cavity 56.

In various implementations, the inner housing 20 defines a first aperture 60a and a second aperture 60b. The first aperture 60a may be disposed proximate a first end 62a of the inner housing 20 and the second aperture 60b may be disposed proximate a second end 62b opposite the first end 62a. The first and second apertures 60a, 60b are in fluid communication with the cavity 56.

In various implementations, the cavity 56 is accessible through the first end 62a via the first aperture 60a and the cavity 56 is accessible through the second end 62b via the second aperture 60b. In various implementations, a first edge 70a of the inner housing 20 defines the first aperture 60a and a second edge 70b defines the second aperture 60b. The first edge 70a may define a circular or an oval-shaped configuration, among others. The second edge 70b may define a freeform configuration, among others. The second edge 70b may define a shape that is substantially similar to the shape defined by the second edge 40b of the outer housing 18. In this regard, in some implementations, the second edge 70b defines a shape having a plurality (e.g., six) of lobes. In some implementations, a first portion (e.g., three lobes) of the second edge 70b defines a first triangle, and a second portion (e.g., three lobes) of the second edge 70b defines a second triangle. The shape (e.g., plurality of lobes) of the second edge 70b may allow for the most efficient use of the laser assembly 12 through the second aperture 60b.

### Assembled Configuration of Assembly

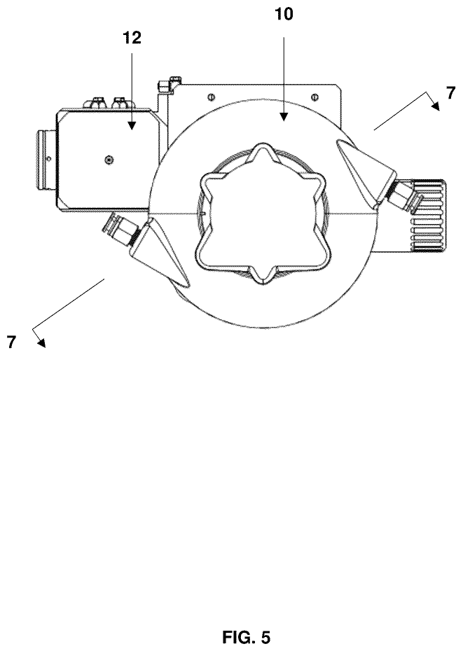

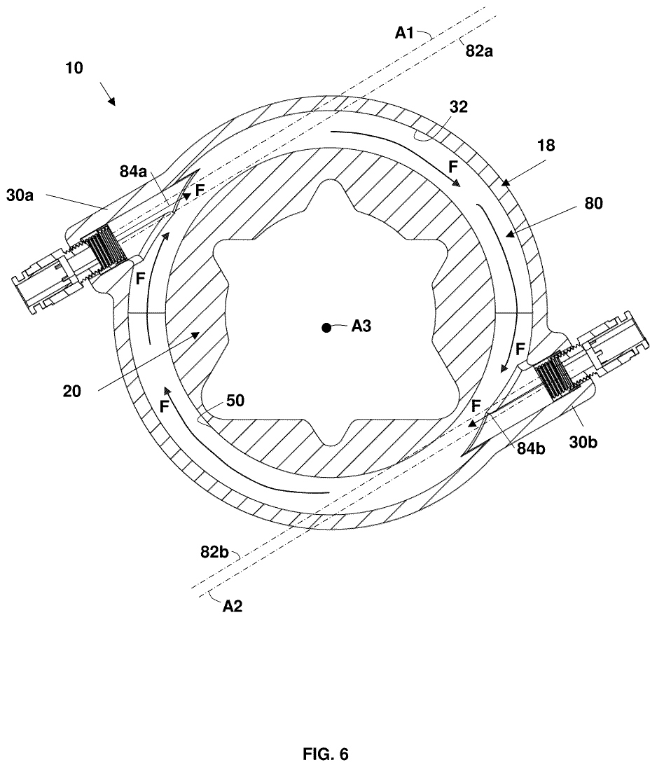

With reference to FIGS. 2 and 5-7, the assembly is 10 shown in the assembled configuration. In the assembled configuration, the inner housing 20 is coupled to the outer housing 18 and is disposed in the cavity 22. Referring now to FIG. 6, the inner surface 32 of the outer housing 18 and the outer surface 50 of the inner housing 20 collectively define a frustoconical fluid flow path 80. The fluid flow path 80 is in communication with the first and second fluid inlets 30a, 30b.

With continued reference to FIG. 6, in various implementations, the first fluid inlet 30a defines a first axis A1 and the second fluid inlet 30b defines a second axis A2. The first axis A1 may be parallel to a first tangent 82a of the outer surface 50 and the second axis A2 may be parallel to a second tangent 82b of the outer surface 50. In various implementation, the first fluid inlet 30a directs fluid F into the fluid flow path 80 in a first direction 84a and the second fluid inlet 30b direction fluid F into the fluid flow path 80 in a second direction 84b opposite the first direction 84a. In various implementations, the configurations of the outer and inner housings 18, 20 and the first and second fluid inlets 30a, 30b cause the fluid F to flow through the fluid flow path 80 in a vortex-shaped configuration.

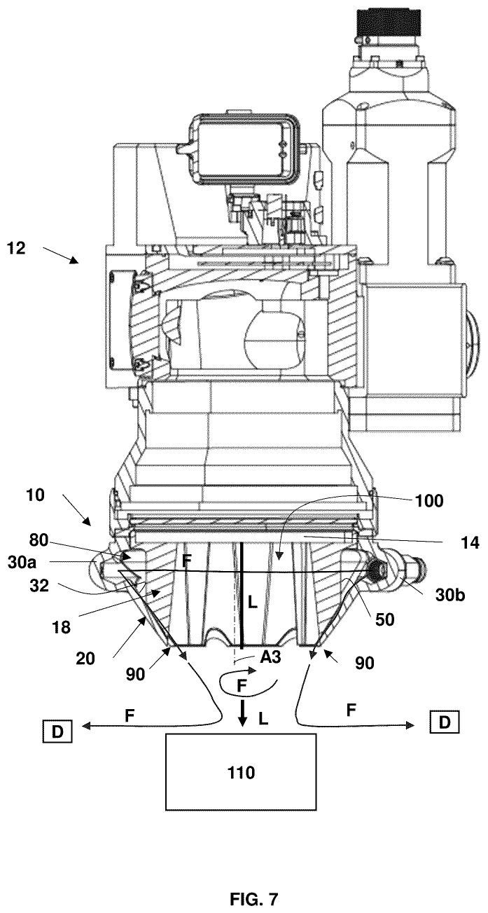

With reference to FIGS. 6 and 7, in various implementations, the outer and inner housings 18, 20 extend along a third axis A3. The first axis A3 may be orthogonal to the first and second axes A1, A2. The fluid flow path 80 may be disposed about the third axis A3.

Referring now to FIG. 7, in various implementations, the outer and inner housings 18, 20 collectively define a fluid outlet 90. The fluid outlet 90 is in communication with the fluid flow path 80 and the first and second inlets 30a, 30b. In various implementations, the configurations of the outer and inner housings 18, 20 cause the fluid F to exit the fluid outlet 90 in a vortex-shaped configuration.

In various implementations, the outer and inner housings 18, 20 collectively define a laser beam passage 100. As will be explained in further details below, laser beams L transmitted by the laser assembly 12 may pass though the assembly 10 via the laser beam passage 100. In some example configurations, the fluid flow path 80 is disposed about the laser beam passage 100.

### Operation of Assembly

With continued reference to FIG. 7, in laser welding applications, the laser assembly 12 transmits laser beams L through the lens 14 and the laser beam passage 100 to weld at least one workpiece 110. The welding operation may cause debris D to be generated from the workpiece 110 and/or the surrounding area of the workpiece 110. In various implementations, the vortex-shaped flow of fluid F that exits the fluid outlet 90 inhibits the debris D from entering the laser beam passage 100 and contacting the lens 14. For example, the fluid F moves the debris D away from the laser beam passage 100 and the lens 14. The velocity of the debris D may decrease as the distance of the debris D from the workpiece 110 increases, such that the velocity of the debris D is at its lowest at its furthest distance from the workpiece 110 and closest distance to the lens 14. In this regard, by locating the lens protector assembly 10 on the laser assembly 12, the lens protector assembly 10, and the fluid F, is able to contact and, thereby deflect, the debris D at its lowest velocity. The assembly 10 protects both the lens 14 and the quality of the weld, extending the life of the laser assembly 12 and improving the reliability of the welding process.

### Materials and Construction of Housings

The outer housing 18 and the inner housing 20 may each be formed from one or more of a variety of materials. In various implementations, one or both of the outer housing 18 and the inner housing 20 are formed from a rigid material. For example, one or both of the outer housing 18 and the inner housing 20 may be formed from a metal (e.g., aluminum, stainless steel, titanium, etc.), a polymer (e.g., a thermoplastic such as polyetheretherketone (PEEK), polycarbonate, or nylon), a composite material, or a combination thereof. In some implementations, the outer housing 18 and the inner housing 20 are formed from the same material. In other implementations, the outer housing 18 and the inner housing 20 are formed from different materials. In some implementations, one or both of the outer housing 18 and the inner housing 20 are formed from a material that is resistant to heat, corrosion, and/or chemical exposure, which may be beneficial given the environment in which the assembly 10 is used (e.g., laser welding). In various implementations, one or both of the outer housing 18 and the inner housing 20 are formed by machining, casting, injection molding, additive manufacturing (e.g., three-dimensional printing), or a combination thereof.

### Coupling of Inner and Outer Housings

The inner housing 20 may be coupled to the outer housing 18 in a variety of ways. In various implementations, the inner housing 20 is coupled to the outer housing 18 via a snap-fit, a press-fit, one or more fasteners (e.g., screws, bolts, pins, etc.), an adhesive, a weld, or a combination thereof. In some implementations, the inner housing 20 is removably coupled to the outer housing 18, such that the inner housing 20 can be separated from the outer housing 18 and reattached thereto. This removable coupling may facilitate cleaning, inspection, replacement, or reconfiguration of one or both of the inner housing 20 and the outer housing 18. In some implementations, the inner housing 20 is permanently coupled to the outer housing 18. In various implementations, the coupling between the inner housing 20 and the outer housing 18 is configured to maintain the concentric disposition of the inner housing 20 within the cavity 22 of the outer housing 18 during operation of the assembly 10, including when pressurized fluid F flows through the fluid flow path 80.

### Fluid Supply and Fittings

As noted above, the first and second fluid inlets 30a, 30b may each connect, via one or more fittings 34, with an air supply line so that fluid (e.g., pressurized air) can be supplied to the assembly 10. In various implementations, the fluid is pressurized air supplied at a pressure sufficient to generate a vortex-shaped flow through the fluid flow path 80 and out of the fluid outlet 90. In some implementations, the fluid is a gas other than air, such as nitrogen or an inert gas, which may be beneficial in certain welding environments where air could adversely affect the weld or the workpiece 110. In some implementations, the fittings 34 are quick-connect fittings that allow the air supply lines to be rapidly connected to and disconnected from the fluid inlets 30a, 30b. In various implementations, the fluid supply pressure is adjustable, allowing an operator to control the velocity and volume of fluid flowing through the assembly 10 and exiting the fluid outlet 90. The ability to adjust the fluid supply pressure may allow the assembly 10 to be tuned for different laser welding applications, workpiece materials, or debris characteristics.

### Detachable Coupling to Laser Assembly

As noted above, the assembly 10 may be detachably coupled to the laser assembly 12 via one or more magnets 16. In various implementations, the magnets 16 are permanent magnets. In some implementations, the magnets 16 are embedded in or affixed to the outer housing 18, and corresponding ferromagnetic or magnetic elements are provided on the laser assembly 12, such that the assembly 10 can be magnetically attached to and detached from the laser assembly 12. The detachable coupling between the assembly 10 and the laser assembly 12 allows the assembly 10 to be quickly and easily attached to and removed from the laser assembly 12, which may facilitate maintenance, replacement, or reconfiguration of the assembly 10. In some implementations, the detachable coupling is configured so that the assembly 10 can be attached to the laser assembly 12 in a single orientation, which may help to ensure proper alignment of the assembly 10 with the laser assembly 12 and the laser beam passage 100. In other implementations, the detachable coupling is configured so that the assembly 10 can be attached to the laser assembly 12 in multiple orientations. In some implementations, the assembly 10 may be detachably coupled to the laser assembly 12 via one or more mechanical fasteners (e.g., screws, bolts, clamps, etc.), a bayonet mount, a threaded connection, or a combination of any of the foregoing, in addition to or instead of the magnets 16.

### Alternative Applications

While the assembly 10 is described herein primarily in the context of laser welding applications, it will be appreciated that the assembly 10 may be used in other applications where it is desirable to protect a lens or other optical element from debris or contamination. For example, the assembly 10 may be used in laser cutting, laser marking, laser engraving, laser drilling, or other laser processing applications. In some implementations, the assembly 10 may be used with laser assemblies other than laser welding assemblies, including, for example, laser scanning assemblies, laser measurement assemblies, or other laser assemblies having a lens that may be exposed to debris or contamination during operation. In various implementations, the fluid used in the assembly 10 need not be air, but may be any fluid (gas or liquid) suitable for creating a vortex-shaped flow through the fluid flow path 80 that is capable of deflecting debris away from the lens 14. In some implementations, the assembly 10 may be scaled up or down in size to accommodate lenses of different sizes or laser assemblies of different configurations.

### Conclusion

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. In the written description and claims, one or more steps within a method may be executed in a different order (or concurrently) without altering the principles of the present disclosure. Similarly, one or more instructions stored in a non-transitory computer-readable medium may be executed in a different order (or concurrently) without altering the principles of the present disclosure. Unless indicated otherwise, numbering or other labeling of instructions or method steps is done for convenient reference, not to indicate a fixed order.

Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

Spatial and functional relationships between elements (for example, between modules, circuit elements, semiconductor layers, etc.) are described using various terms, including “connected,” “engaged,” “coupled,” “adjacent,” “proximate,” “next to,” “on top of,” “above,” “below,” and “disposed.” Unless explicitly described as being “direct,” when a relationship between first and second elements is described in the above disclosure, that relationship encompasses a direct relationship where no other intervening elements are present between the first and second elements as well as an indirect relationship where one or more intervening elements are present between the first and second elements. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The term “set” does not necessarily exclude the empty set —in other words, in some circumstances a “set” may have zero elements. The term “non-empty set” may be used to indicate exclusion of the empty set —in other words, a non-empty set will always have one or more elements. The term “subset” does not necessarily require a proper subset. In other words, a “subset” of a first set may be coextensive with (equal to) the first set. Further, the term “subset” does not necessarily exclude the empty set —in some circumstances a “subset” may have zero elements.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

The phrase “at least one of A, B, and C” should be construed to mean a logical (A OR B OR C), using a non-exclusive logical OR, and should not be construed to mean “at least one of A, at least one of B, and at least one of C.” The phrase “at least one of A, B, or C” should be construed to mean a logical (A OR B OR C), using a non-exclusive logical OR.

Various example embodiments of the invention are described in the following clauses.

Clause 1: A lens protector assembly for a laser having a lens, the lens protector assembly comprising: an outer housing including a fluid inlet and a frustoconical inner surface defining a cavity, the fluid inlet defining an axis; and an inner housing coupled to the outer housing and concentrically disposed within the cavity, the inner housing including a frustoconical outer surface, wherein the axis is parallel to a tangent of the outer surface, and wherein the inner and outer surfaces collectively define a frustoconical fluid flow path in communication with the fluid inlet.

Clause 2: The lens protector assembly of clause 1, wherein: the outer and inner housings extend along a second axis orthogonal to the axis, and the fluid flow path is disposed about the second axis.

Clause 3: The lens protector assembly of any of clauses 1 through 2, wherein the lens protector assembly is configured so that fluid flows through the fluid flow path in a vortex-shaped configuration.

Clause 4: The lens protector assembly of any of clauses 1 through 3, wherein the outer and inner housings collectively define a fluid outlet in communication with the fluid flow path.

Clause 5: The lens protector assembly of clause 4, wherein the lens protector assembly is configured so that a vortex-shaped flow of fluid exits the fluid outlet.

Clause 6: The lens protector assembly of clause 5, wherein the vortex-shaped flow of fluid inhibits debris from contacting the lens.

Clause 7: The lens protector assembly of any of clauses 1 through 6, wherein the outer housing includes an additional fluid inlet.

Clause 8: The lens protector assembly of clause 7, wherein: the fluid inlet is configured to direct fluid into the fluid flow path in a first direction, and the additional fluid inlet is configured to direct fluid into the fluid flow path in a second direction opposite the first direction.

Clause 9: The lens protector assembly of any of clauses 1 through 8, wherein: the outer and inner housings collectively define a laser beam passage, and the fluid flow path is disposed about the laser beam passage.

Clause 10: The lens protector assembly of any of clauses 1 through 9, wherein: the outer housing includes a first edge defining a first aperture at a first end of the outer housing and a second edge defining a second aperture at a second end of the outer housing opposite the first end, and the first and second apertures are in fluid communication with the cavity.

Clause 11: The lens protector assembly of clause 10, wherein the first edge of the outer housing defines a circular or oval-shaped configuration.

Clause 12: The lens protector assembly of clause 10, wherein the second edge of the outer housing defines a freeform configuration having a plurality of lobes.

Clause 13: The lens protector assembly of clause 12, wherein a first portion of the plurality of lobes defines a first triangle and a second portion of the plurality of lobes defines a second triangle.

Clause 14: The lens protector assembly of any of clauses 1 through 13, wherein: the inner housing includes a first edge defining a first aperture at a first end of the inner housing and a second edge defining a second aperture at a second end of the inner housing opposite the first end, and the first and second apertures of the inner housing are in fluid communication with a cavity defined by an inner surface of the inner housing.

Clause 15: The lens protector assembly of clause 14, wherein the second edge of the inner housing defines a freeform configuration that is substantially similar to a shape defined by a second edge of the outer housing.

Clause 16: The lens protector assembly of any of clauses 1 through 15, wherein the frustoconical outer surface of the inner housing includes a first portion defining a ring-shaped configuration and a set of second portions extending from the first portion.

Clause 17: The lens protector assembly of any of clauses 1 through 16, wherein the fluid inlet includes a fitting configured to connect the fluid inlet to a fluid supply line.

Clause 18: A laser assembly comprising: a laser including a lens; and the lens protector assembly of any of clauses 1 through 17, wherein the lens protector assembly is detachably coupled to the laser and encloses at least a portion of the lens.

Clause 19: The laser assembly of clause 18, wherein the lens protector assembly is detachably coupled to the laser via one or more magnets.

Clause 20: The laser assembly of any of clauses 18 through 19, wherein: the outer and inner housings collectively define a laser beam passage and a fluid outlet in communication with the fluid flow path, and the lens protector assembly is configured so that a vortex-shaped flow of fluid exits the fluid outlet about the laser beam passage to inhibit debris from contacting the lens.

1. A lens protector assembly for a laser having a lens, the lens protector assembly comprising:
an outer housing including a fluid inlet and a frustoconical inner surface defining a cavity, the fluid inlet defining an axis; and
an inner housing coupled to the outer housing and concentrically disposed within the cavity, the inner housing including a frustoconical outer surface,
wherein the axis is parallel to a tangent of the outer surface, and
wherein the inner and outer surfaces collectively define a frustoconical fluid flow path in communication with the fluid inlet.

2. The lens protector assembly of claim 1 wherein:
the outer and inner housings extend along a second axis orthogonal to the axis, and
the fluid flow path is disposed about the second axis.

3. The lens protector assembly of claim 1 wherein the lens protector assembly is configured so that fluid flows through the fluid flow path in a vortex-shaped configuration.

4. The lens protector assembly of claim 1 wherein the outer and inner housings collectively define a fluid outlet in communication with the fluid flow path.

5. The lens protector assembly of claim 4 wherein the lens protector assembly is configured so that a vortex-shaped flow of fluid exits the fluid outlet.

6. The lens protector assembly of claim 5 wherein the vortex-shaped flow of fluid inhibits debris from contacting the lens.

7. The lens protector assembly of claim 1 wherein the outer housing includes an additional fluid inlet.

8. The lens protector assembly of claim 7 wherein:
the fluid inlet is configured to direct fluid into the fluid flow path in a first direction, and
the additional fluid inlet is configured to direct fluid into the fluid flow path in a second direction opposite the first direction.

9. The lens protector assembly of claim 1 wherein:
the outer and inner housings collectively define a laser beam passage, and
the fluid flow path is disposed about the laser beam passage.

10. The lens protector assembly of claim 1 wherein:
the outer housing includes a first edge defining a first aperture at a first end of the outer housing and a second edge defining a second aperture at a second end of the outer housing opposite the first end, and
the first and second apertures are in fluid communication with the cavity.

11. The lens protector assembly of claim 10 wherein the first edge of the outer housing defines a circular or oval-shaped configuration.

12. The lens protector assembly of claim 10 wherein the second edge of the outer housing defines a freeform configuration having a plurality of lobes.

13. The lens protector assembly of claim 12 wherein a first portion of the plurality of lobes defines a first triangle and a second portion of the plurality of lobes defines a second triangle.

14. The lens protector assembly of claim 1 wherein:
the inner housing includes a first edge defining a first aperture at a first end of the inner housing and a second edge defining a second aperture at a second end of the inner housing opposite the first end, and
the first and second apertures of the inner housing are in fluid communication with a cavity defined by an inner surface of the inner housing.

15. The lens protector assembly of claim 14 wherein the second edge of the inner housing defines a freeform configuration that is substantially similar to a shape defined by a second edge of the outer housing.

16. The lens protector assembly of claim 1 wherein the frustoconical outer surface of the inner housing includes a first portion defining a ring-shaped configuration and a set of second portions extending from the first portion.

17. The lens protector assembly of claim 1 wherein the fluid inlet includes a fitting configured to connect the fluid inlet to a fluid supply line.

18. A laser assembly comprising:
a laser including a lens; and
the lens protector assembly of claim 1,
wherein the lens protector assembly is detachably coupled to the laser and encloses at least a portion of the lens.

19. The laser assembly of claim 18 wherein the lens protector assembly is detachably coupled to the laser via one or more magnets.

20. The laser assembly of claim 18 wherein:
the outer and inner housings collectively define a laser beam passage and a fluid outlet in communication with the fluid flow path, and
the lens protector assembly is configured so that a vortex-shaped flow of fluid exits the fluid outlet about the laser beam passage to inhibit debris from contacting the lens.
